(19) United States
(12) Patent Application Publication
(10) Pub. No.: US 2006/0261564 A1
(43) Pub. Date: Nov. 23, 2006

(54) Luggage carrier

(76) Inventor: Chiu-Min Chuang, Taichung Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/130,992

(22) Filed: May 17, 2005

(51) Int. Cl. B62B 1/00

(52) U.S. Cl. 280/47.27

(57) ABSTRACT

A luggage carrier includes a support base, two side brackets telescopically mounted on two opposite sides of the support base, and a telescopically arranged handle assembly pivotally and foldably mounted on an end of the support base. Thus, each of the side brackets is movable outward relative to the support base to expand the two side brackets so as to increase and adjust the width of the support base so that the luggage carrier can bear a larger load. In addition, the handle assembly is received in the receiving slots of the support base, thereby folding the handle assembly so that the handle assembly is folded when not in use.

### BACKGROUND OF THE INVENTION

1. Field of the Invention

The present invention relates to a luggage carrier, and more particularly to a luggage carrier having an adjustable width.

2. Description of the Related Art

A conventional luggage carrier comprises a stand for supporting a luggage, a handle mounted on an end of the stand, and a wheel unit mounted on the bottom of the stand. However, the stand has a fixed width so that the stand is used to bear a determined load, thereby limiting the versatility of the luggage carrier. In addition, the stand is unstable when supporting an excessive load, so that the luggage carrier is easily upset.

The closest prior art reference of which the applicant is aware was disclosed in the Taiwanese Patent Publication No. 285852.

### SUMMARY OF THE INVENTION

The primary objective of the present invention is to provide a luggage carrier having an adjustable width.

Another objective of the present invention is to provide a luggage carrier, wherein each of the two side brackets is movable outward relative to the support base to expand the two side brackets so as to increase and adjust the width of the support base so that the luggage carrier can bear a larger load.

A further objective of the present invention is to provide a luggage carrier, wherein the handle assembly is received in the receiving slots of the support base, thereby folding the handle assembly so that the handle assembly is folded when not in use, thereby saving the space and thereby facilitating package, storage and transportation of the luggage carrier.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a luggage carrier in accordance with the preferred embodiment of the present invention;

FIG. 2 is a partially exploded perspective view of the luggage carrier as shown in FIG. 1;

FIG. 3 is a plan cross-sectional view of the luggage carrier as shown in FIG. 1;

FIG. 4 is a schematic operational view of the luggage carrier as shown in FIG. 1;

FIG. 5 is a partially exploded perspective view of the luggage carrier as shown in FIG. 1;

FIG. 6 is a plan cross-sectional view of the luggage carrier as shown in FIG. 1; and

FIG. 7 is a schematic operational view of the luggage carrier as shown in FIG. 1.

### DETAILED DESCRIPTION OF THE INVENTION

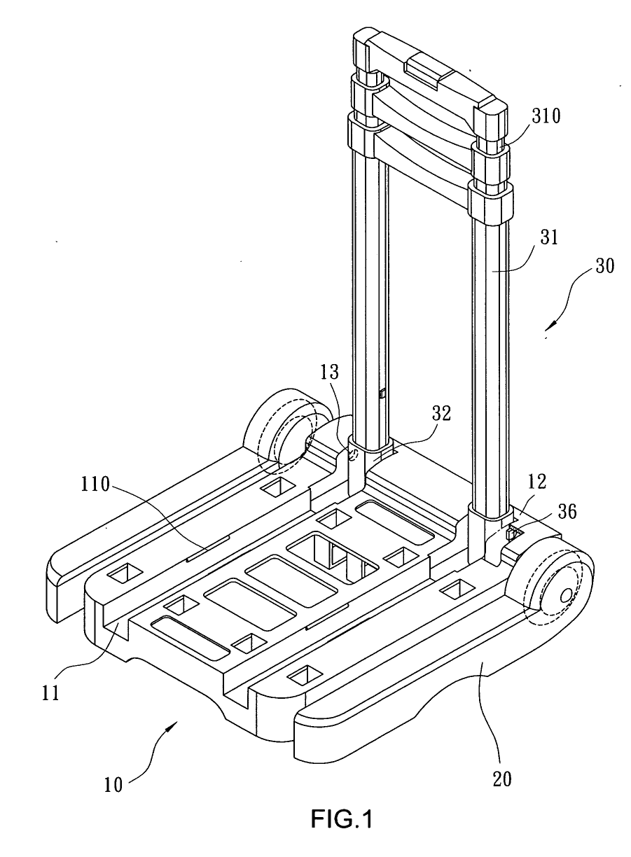

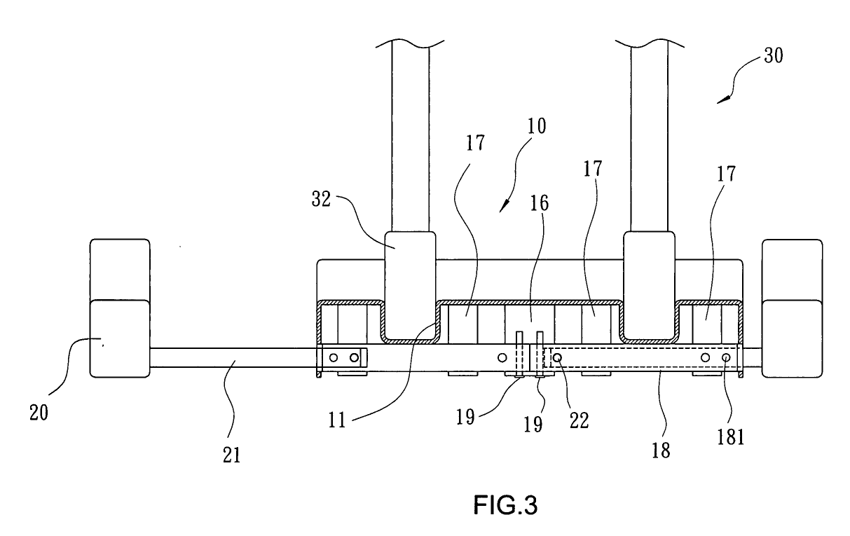

Referring to the drawings and initially to FIGS. 1-3, a luggage carrier in accordance with the preferred embodiment of the present invention comprises a support base 10, two side brackets 20 telescopically mounted on two opposite sides of the support base 10, and a telescopically arranged handle assembly 30 pivotally and foldably mounted on an end of the support base 10.

Each of the two opposite sides of the support base 10 is provided with two spaced guide tracks 18 each having two ends each formed with a positioning hole 181. The support base 10 has two spaced mounting channels 15 each transversely extended through the two opposite sides of the support base 10 for mounting two guide tracks 18 juxtaposed to each other. Each of the two mounting channels 15 of the support base 10 has a bottom face having a mediate portion formed with a main support seat 16 for supporting and fixing the two juxtaposed guide tracks 18 by two locking bolts 19. The main support seat 16 of each of the two mounting channels 15 of the support base 10 has two sides each provided with two spaced secondary support seats 17 for supporting the respective guide track 18.

The support base 10 has a top face formed with two longitudinally arranged receiving slots 11 for receiving the handle assembly 30 when the handle assembly 30 is folded onto the support base 10. Each of the receiving slots 11 of the support base 10 has an open first end and a closed second end 12. The closed second end 12 of each of the receiving slots 11 of the support base 10 has a side face formed with a pivot hole 14 and a locking hole 13 located above the pivot hole 14. Each of the receiving slots 11 of the support base 10 has a mediate portion having a top edge provided with a protruding limit portion 110 for limiting the handle assembly 30.

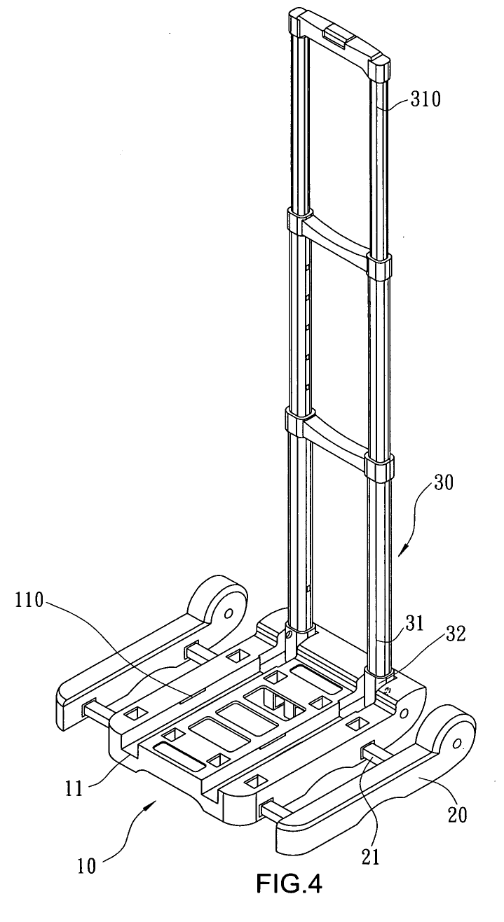

Each of the two side brackets 20 has a length substantially equal to that of the support base 10. Each of the two side brackets 20 has two spaced slide bars 21 each slidably mounted in a respective one of the guide tracks 18 of the support base 10 and each having a distal end provided with a retractably arranged positioning ball 22 detachably positioned in the positioning hole 181 of the respective guide track 18 of the support base 10. Thus, the slide bars 21 each of the two side brackets 20 are slidable in the guide tracks 18 of the support base 10 so that each of the two side brackets 20 is movable outward relative to the support base 10 to expand the two side brackets 20 as shown in FIG. 4 so as to increase and adjust the width of the support base 10.

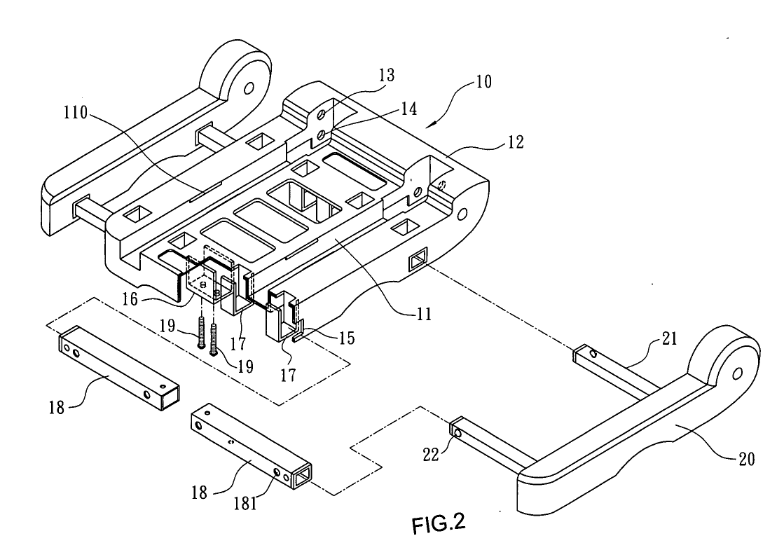

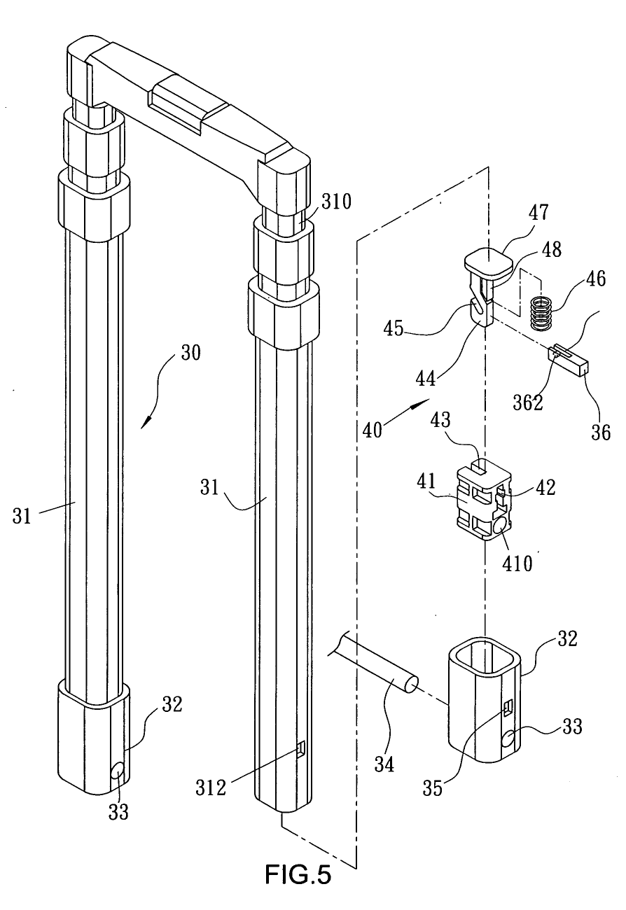

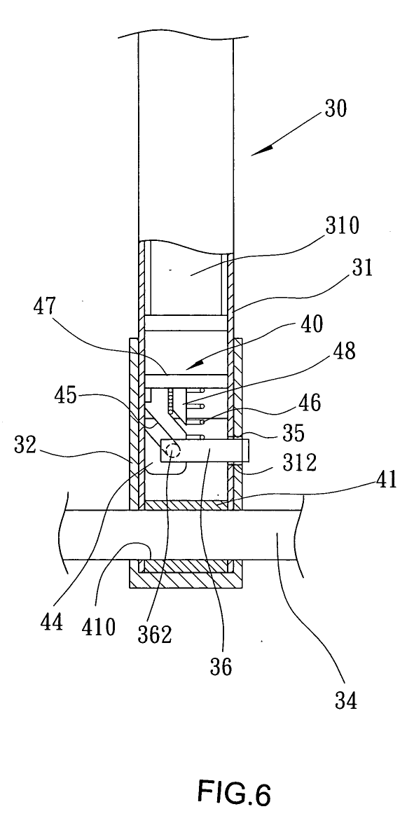

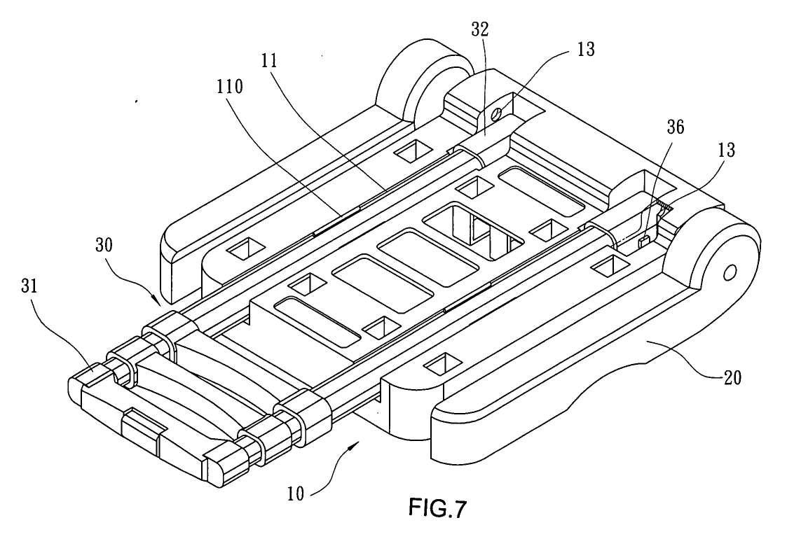

Referring to FIGS. 4-7 with reference to FIGS. 1 and 2, the handle assembly 30 includes two spaced outer tubes 31 each pivotally mounted in a respective one of the receiving slots 11 of the support base 10 and each having a lower end formed with a through hole 312, at least two inner tubes 310 each movably mounted in a respective one of the outer tubes 31, two sleeves 32 each pivotally mounted in a respective one of the receiving slots 11 of the support base 10 and each mounted on a respective one of the outer tubes 31, a pivot shaft 34 extended through the closed second end 12 of each of the receiving slots 11 of the support base 10 and each of the two sleeves 32 and having two ends each mounted in the respective pivot hole 14 of the support base 10, and two locking tenons 36 each having a first end extended through a respective one of the outer tubes 31 and a respective one of the sleeves 32 and each detachably locked in the locking hole 13 of a respective one of the receiving slots 11 of the support base 10. Each of the two sleeves 32 is pivotally mounted on the pivot shaft 34 and has a lower portion formed with a rotation hole 33 rotatably mounted on the pivot shaft 34. Each of the two sleeves 32 has a side formed with a fixing hole 35 located above the rotation hole 33. The first end of each of the two locking tenons 36 is extended through the through hole 312 of a respective one of the outer tubes 31 and the fixing hole 35 of a respective one of the sleeves 32 and protruded outward from the fixing hole 35. Each of the two locking tenons 36 has a second end formed with a guide slot 361 and provided with a guide pin 362 located in the guide slot 361.

The handle assembly 30 further includes two release mechanisms 40 each mounted in a respective one of the outer tubes 31 and connected to a respective one of the locking tenons 36 to move the respective locking tenon 36 to detach from the locking hole 13 of the respective receiving slot 11 of the support base 10. Each of the release mechanisms 40 includes a plug 41 secured in a respective one of the sleeves 32 and having a first side formed with a transverse slot 42 to allow movement of a respective one of the locking tenons 36 and a second side formed with a longitudinal slot 43 connected to the transverse slot 42, a guide block 44 slidably mounted in the longitudinal slot 43 of the plug 41 and the guide slot 361 of the respective locking tenon 36 and has a lower end formed with an oblique push slot 45 pressed on the guide pin 362 of the respective locking tenon 36 and an upper end formed with a press face 47 facing a lower end of a respective one of the inner tubes 310, and an elastic member 46 mounted between the plug 41 and the press face 47 of the guide block 44. The press face 47 of the guide block 44 of each of the release mechanisms 40 has a bottom provided with a mounting post 48 for mounting the elastic member 46. The longitudinal slot 43 of the plug 41 of each of the release mechanisms 40 has a width smaller than that of the transverse slot 42 to limit the respective locking tenon 36 to move in the transverse slot 42. The plug 41 of each of the release mechanisms 40 has a lower end formed with a shaft hole 410 pivotally mounted on the pivot shaft 34.

In operation, when the press face 47 of the guide block 44 of each of the release mechanisms 40 is pressed by the lower end of a respective one of the inner tubes 310, the guide block 44 is moved downward to compress the elastic member 46 and the oblique push slot 45 of the guide block 44 is moved downward to press the guide pin 362 of the respective locking tenon 36 inward so that the respective locking tenon 36 is retracted inward to detach from the locking hole 13 of the respective receiving slot 11 of the support base 10, thereby releasing each of the outer tubes 31 of the handle assembly 30 from the respective receiving slot 11 of the support base 10. Thus, the handle assembly 30 is released from and pivoted relative to the support base 10 so that the handle assembly 30 is received in the receiving slots 11 of the support base 10, thereby folding the handle assembly 30.

Accordingly, each of the two side brackets 20 is movable outward relative to the support base 10 to expand the two side brackets 20 so as to increase and adjust the width of the support base 10 so that the luggage carrier can bear a larger load. In addition, the handle assembly 30 is received in the receiving slots 11 of the support base 10, thereby folding the handle assembly 30 so that the handle assembly 30 is folded when not in use, thereby saving the space and thereby facilitating package, storage and transportation of the luggage carrier.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A luggage carrier, comprising:
a support base;
two side brackets telescopically mounted on two opposite sides of the support base;
a telescopically arranged handle assembly pivotally and foldably mounted on an end of the support base.

2. The luggage carrier in accordance with claim 1, wherein each of the two opposite sides of the support base is provided with two spaced guide tracks each having two ends each formed with a positioning hole.

3. The luggage carrier in accordance with claim 2, wherein the support base has two spaced mounting channels each transversely extended through the two opposite sides of the support base for mounting two guide tracks juxtaposed to each other.

4. The luggage carrier in accordance with claim 3, wherein each of the two mounting channels of the support base has a bottom face having a mediate portion formed with a main support seat for supporting and fixing the two juxtaposed guide tracks by two locking bolts.

5. The luggage carrier in accordance with claim 4, wherein the main support seat of each of the two mounting channels of the support base has two sides each provided with two spaced secondary support seats for supporting the respective guide track.

6. The luggage carrier in accordance with claim 2, wherein each of the side brackets has two slide bars each slidably mounted in a respective one of the guide tracks of the support base and each having a distal end provided with a retractably arranged positioning ball detachably positioned in the positioning hole of the respective guide track of the support base.

7. The luggage carrier in accordance with claim 1, wherein the slide bars each of the two side brackets are slidable in the guide tracks of the support base so that each of the two side brackets is movable outward relative to the support base to expand the two side brackets so as to increase and adjust the width of the support base.

8. The luggage carrier in accordance with claim 1, wherein each of the two side brackets has a length substantially equal to that of the support base.

9. The luggage carrier in accordance with claim 1, wherein the support base has a top face formed with two longitudinally arranged receiving slots for receiving the handle assembly when the handle assembly is folded onto the support base.

10. The luggage carrier in accordance with claim 9, wherein each of the receiving slots of the support base has a mediate portion having a top edge provided with a protruding limit portion for limiting the handle assembly.

11. The luggage carrier in accordance with claim 9, wherein the handle assembly includes two spaced outer tubes each pivotally mounted in a respective one of the receiving slots of the support base, and at least two inner tubes each movably mounted in a respective one of the outer tubes.

12. The luggage carrier in accordance with claim 11, wherein each of the receiving slots of the support base has an open first end and a closed second end, the closed second end of each of the receiving slots of the support base has a side face formed with a pivot hole and a locking hole located above the pivot hole, and the handle assembly further includes two sleeves each pivotally mounted in a respective one of the receiving slots of the support base and each mounted on a respective one of the outer tubes, a pivot shaft extended through the closed second end of each of the receiving slots of the support base and each of the two sleeves and having two ends each mounted in the respective pivot hole of the support base, and two locking tenons each having a first end extended through a respective one of the outer tubes and a respective one of the sleeves and each detachably locked in the locking hole of a respective one of the receiving slots of the support base.

13. The luggage carrier in accordance with claim 12, wherein each of the two sleeves is pivotally mounted on the pivot shaft and has a lower portion formed with a rotation hole rotatably mounted on the pivot shaft.

14. The luggage carrier in accordance with claim 12, wherein each of the outer tubes has a lower end formed with a through hole, each of the two sleeves has a side formed with a fixing hole, and the first end of each of the two locking tenons is extended through the through hole of a respective one of the outer tubes and the fixing hole of a respective one of the sleeves and protruded outward from the fixing hole.

15. The luggage carrier in accordance with claim 12, wherein the handle assembly further includes two release mechanisms each mounted in a respective one of the outer tubes and connected to a respective one of the locking tenons to move the respective locking tenon to detach from the locking hole of the respective receiving slot of the support base.

16. The luggage carrier in accordance with claim 15, wherein each of the two locking tenons has a second end formed with a guide slot and provided with a guide pin located in the guide slot, and each of the release mechanisms includes a plug secured in a respective one of the sleeves and having a first side formed with a transverse slot to allow movement of a respective one of the locking tenons and a second side formed with a longitudinal slot connected to the transverse slot, a guide block slidably mounted in the longitudinal slot of the plug and the guide slot of the respective locking tenon and has a lower end formed with an oblique push slot pressed on the guide pin of the respective locking tenon and an upper end formed with a press face facing a lower end of a respective one of the inner tubes, and an elastic member mounted between the plug and the press face of the guide block.

17. The luggage carrier in accordance with claim 16, wherein the press face of the guide block of each of the release mechanisms has a bottom provided with a mounting post for mounting the elastic member.

18. The luggage carrier in accordance with claim 16, wherein the longitudinal slot of the plug of each of the release mechanisms has a width smaller than that of the transverse slot to limit the respective locking tenon to move in the transverse slot.

19. The luggage carrier in accordance with claim 16, wherein the plug of each of the release mechanisms has a lower end formed with a shaft hole pivotally mounted on the pivot shaft.

20. The luggage carrier in accordance with claim 16, wherein when the press face of the guide block of each of the release mechanisms is pressed by the lower end of a respective one of the inner tubes, the guide block is moved downward to compress the elastic member and the oblique push slot of the guide block is moved downward to press the guide pin of the respective locking tenon inward so that the respective locking tenon is retracted inward to detach from the locking hole of the respective receiving slot of the support base, thereby releasing each of the outer tubes of the handle assembly from the respective receiving slot of the support base.
